(19) United States
(12) Patent Application Publication
(10) Pub. No.: US 2007/0175562 A1
(43) Pub. Date: Aug. 2, 2007

(54) Lock and key bonding system

(75) Inventor: Fred N. Miekka, Arcadia, CA (US)

Correspondence Address: FRANK A. PALASE, SUITE 203, 141 E. HUNTINGTON DRIVE, ARCADIA, CA, 91006, US

(73) Assignee: SIERRA MADRE MARKETING GROUP

(21) Appl. No.: 11/700,927

(22) Filed: Feb. 1, 2007

Related U.S. Application Data
(60) Provisional application No. 60/764,089, filed on Feb. 1, 2006.

(51) Int. Cl. B31B 1/60

(52) U.S. Cl. 156/60; 156/330

(57) ABSTRACT

Interlocking bonding surfaces for use with bonding agents are disclosed having unique lock and key geometries that may be matched to each other in one or more ways. One part may have holes in a specific configuration while the matched part has protrusions or alternatively, one part may have both protrusions and holes that interlock with those of the other matching part. Such configurations provide a one way fit between parts in addition to providing authentication and control of specific components.

### CROSS REFERENCE TO RELATED APPLICATIONS

This non-provisional application claims benefit of the provisional application filed on Feb. 1, 2006 having U.S. application number 60/764,089.

### BACKGROUND OF THE INVENTION

1. Field of the Invention

This invention relates to bonding surfaces together with bonding agents. More particularly this invention relates to bonding surfaces having unique geometries providing one way fit characteristics along with numerous possible configurations. The bonding surfaces of this invention provide a large number of combinations based on protrusion and space interlocking geometries. Numerous combinations are provided by the matching location of protrusions and spaces/holes on the individual bonding surfaces themselves. The large number of matched bonding surface combinations of this invention provides the benefit of part verification, authentication of origin, tamper evident constructions, and anti-counterfeit protection.

2. Description of the Related Art

There are numerous methods that may be employed to bond two surfaces together.

These methods may employ one or more of the following basic principles. Mechanical interlocking, surface adhesion, and the welding.

A good description of bonding can be found in the background portion of U.S. Pat. No. 6,692,813 titled “Multilayered Spherical Bonding Construction and awarded to Allen H Elder.

This description provides a general summary of bonding and helps to illustrate bond strength advantages associated with mechanical interlocking. In particular, Allen Elder's invention employs bonding substrates having one or more layers of surface particulates that are part of the substrate itself and are in phase with the substrate. These substrates may be used to form strong interlocking bonds with bonding agents.

Bonding agents are materials that may be used to afford a bond between two or more substrates. Bonding agents may be chosen from a wide variety of materials. Many bonding agents are applied as liquids that later harden into a solid mass. Liquid bonding agents serve to initially wet out bonding surfaces and later harden thereby holding the surfaces together.

The following bonding mechanisms are described about in U.S. Pat. No. 6,692,813.

1. Surface adhesion.

2. Mechanical anchorage.

3. welding

Surface adhesion may rely on chemical bonding and molecular attraction between a bonding agent and substrate. The substrate surface to be bonded may form chemical bonds such as ionic and/or covalent to the bonding agent. Polar forces between substrate and bonding agent molecules may provide surface adhesion as well. These forces may include hydrogen bonding, polarities induced by electric charges and/or electronegative atoms. In summary, surface adhesion generally relies on molecular attractive forces between the bonding agent and substrate surface. Intermingling of substrate molecules and the molecules in the bonding agent may also occur. This intermingling of molecules is the basis of welding and may result in very strong bonds. It should be noted that in the case of welding metals that individual atoms may be involved in the bonding process.

The process of welding intermingles the bonding agent (welding rod material or even the substrate material itself) and substrate (surface of the object to be welded). Since the material being welded is often similar or even identical to the substrate material, a good strong bond occurs. Metal bonding can generally be summarized as the mutual sharing of loose valence electrons between atoms such that they all may share these loose electrons and the loose valence electrons may freely travel from one atom to the next. Loose valence electrons found in many metals contribute metallic properties such as electrical conductivity, thermal conductivity, metallic luster, and malleability.

In the case of welding metals, mutually shared electrons form a continuous mass throughout the welded part. Welding therefore has characteristics of surface adhesion by way of chemical bonding and mechanical anchorage by way of commingling of weld and substrate.

In the case of welding plastics, commingling may occur between the substrate and bonding agent. Like the welding of metals the bonding agent may be either added or come from the substrate itself. Solvents may be employed that dissolve the polymer or polymers making up the substrates to be joined and therefore allow the molecules of one substrate to dissolve into the solvent and commingle with the molecules in the solvent that dissolved molecules from the other substrate. In this way, entanglement of polymer chains may occur as well as molecular attraction between adjacent polymeric chains. The solvent may then evaporate if exposed to the air or alternatively migrate into the polymer mass to slowly evaporate later.

The above described bonding mechanisms may not be exclusive of one another but rather may occur together to some extent at the same time.

The above descriptions outline general bonding theory. Bonding mechanisms are well known art and therefore a detailed description need not be given here.

The bonding of two substrates together with one or more bonding agents can be achieved in numerous ways. Aspects of bonding involving the controlled fit between two or more parts can be achieved by controlling the geometry of part substrates. In particular, it may be desirable to provide part geometries in bonding areas allowing for parts to be joined in only one possible configuration. Such part geometries may help to assure correct part placement prior to bonding them together with a bonding agent. It should be noted that some parts will only fit one way with each other anyway and in these instances modification of part design for one way assembly provides little if any benefit.

Joining two or more parts together with a bonding agent involves not only the strength of the bond but may also depend on proper placement and alignment of parts. Interlocking parts provide a way of achieving a compact one way fit between two or more parts. Furthermore, many interlocking part geometries may be used with bonding agents to achieve this end. This may result in a strong compact bond having a one way fit. Examples of this include various joints used in woodworking such as dovetail and tongue and groove.

As mentioned earlier, bonding agents may be employed to join two or more parts together. The strength of the bond depends on both the substrate and the bonding agent. Substrates employing interlocking surface geometries may benefit from improved bond strength afforded by mechanical anchorage. Furthermore, specific substrate bonding geometries may be employed to provide a secure one way fit between two or more parts.

In addition to bonding substrates together, bonding agents may be used to seal various objects. When objects are placed within the volume of a sealant such as a bonding agent they may be said to be embedded. Embedding articles within bonding agents and/or other sealants may help to protect them from environmental stresses such as moisture, heat, and vibration.

Certain articles may be embedded within other articles for various purposes such as identification, anti-theft, and anti-counterfeit protection. The use of anti-theft protection is becoming more widespread throughout the retail industry. Small circuits having a tuned frequency response may be placed into consumer goods located in retail stores. A powerful electromagnet may then be used at the point of sale to induce a strong current in the circuit to burn it out and thus render it inoperable. The burned out circuit can then pass through a sensor without setting off the alarm. If however a functioning circuit passes by the sensor, the alarm activates indicating possible theft. These embedded circuits can be made low enough in cost to provide an overall savings to the retailer by reducing theft.

Counterfeit products are commonly sold to consumers. These counterfeit products may be labeled as originals and sold to unsuspecting consumers. This may result in reduced sales of legitimate products and may even add to product liability from the use of the inferior counterfeit product.

Numerous methods may be employed to help prevent the counterfeiting and forgery of commercial items. For example, holographic images are being increasingly used to deter counterfeiting and forgery. Holographic stickers are often applied to credit cards to reduce counterfeiting and forgery. Holographic images are images having optical depth and/or refractive color properties resulting from small grooves producing diffraction effects with light. Since an optical copy of a holographic image does not refract light, it is easy to distinguish from the original. Holographic image stickers may be designed to fall apart if tampered with to prevent them from being transferred to other items. In addition it is common practice to place these stickers over the raised numbers of a credit card to further discourage their transfer. Unfortunately, holograms are plentiful and there are so many different credit cards out there, placing any hologram on a counterfeit credit card would fool many individuals. Furthermore, holograms can be copied by casting polymers over the original embossed image.

One particularly interesting approach to employing holographic images for producing counterfeit resistant items is outlined in U.S. Pat. No. 5,624,076 awarded to Richard G, Miekka and others titled “Process for making embossed metallic leafing pigments” This particular patent outlines a process for preparing metal leafing pigments having surface embossment. The surface embossment may take the form of a diffraction image pattern such as a diffraction grating or hologram. The process involves expensive metallization equipment and therefore would be expensive to reproduce. The result is finely divided thin metal film particles having micro-embossment on at least one surface.

These embossed leafing pigments have unique optical properties that are visible to the naked eye and can be further analyzed by optical magnification.

One interesting property of these thin metallic embossed leafing pigments is the fact that the embossment remains on the pigment particles despite their exceedingly small thickness of only a few hundred angstroms. About 100 atoms thick for aluminum.

U.S. Pat. No. 5,672,410 awarded to Richard G, Miekka and others titled “Embossed Metallic Leafing Pigments” gives a detailed description of the leafing pigments themselves. U.S. Pat. No. 6,068,691 awarded to Richard G, Miekka and others titled “Process for making machine readable images” employs embossed metallic leafing pigments having a machine readable pattern such as micro-embossed bar codes. Despite advancements in anti-counterfeit technologies, there is a growing need in the industry to control the proliferation of fraudulent items. In addition, there is a need in certain industries such as the vehicle industry to control interchangeability of parts. For example, many automotive companies are offering extended warranties. It would be desirable for these companies to keep track of accidents and/or other events that require replacement of parts. In addition it would be desirable for consumers to reduce the likelihood of vehicle theft. A significant portion of vehicle theft occurs because the thieves want the parts of the vehicles themselves. Often when a car is stolen it is taken to a “chop shop” (an illegal operation of dismantling stolen cars for their parts). This is often carried out for one or more of the following reasons:

1. The value of the parts often exceeds the value of the car.

2. Individual parts are smaller and therefore easier to conceal.

3. Registration and vehicle identification numbers make stolen cars difficult to sell.

In addition, certain aftermarket parts such as specialty wheels attract thieves. Modifications to a vehicle and custom fit of specialty components that will only fit on that individual vehicle may significantly reduce the temptation of thieves.

The assembly of vehicles having parts that will only fit back on the original would significantly deter theft and may provide a way for vehicle manufacturing companies to avoid warranty fraud.

Furthermore, is such parts are stolen, their unique geometry may be used as a sort of fingerprint for positive identification by investigating authorities.

It is an object of this invention to provide bonding surfaces suitable for forming strong bonds with bonding agents.

It is a further object of this invention to provide bonding surfaces that can be used to provide a one way fit.

It is a further object of this invention to provide bonding surfaces suitable for part verification at a later date.

It is a further object of this invention to provide a means of producing tamper evident constructions.

It is a further object of this invention to provide a way of deterring theft.

It is a further object of this invention to provide a way of controlling individual parts by individual manufacturers.

Finally it is an object of this invention to provide anti-counterfeit protection to consumer articles and the like.

### SUMMARY OF THE INVENTION

This invention therefore proposes bonding surfaces having unique geometries that may only be bonded to other matching surfaces. This method of bonding may employ matching holes and protrusions to provide a lock and key fit. A large number of unique lock and key combinations are possible based on binary math.

Various methods may be employed to prepare these bonding surfaces including casting and molding operations, machining, and forming operations.

The bonding substrates may be made from any number of materials including preformed composite components, metal parts and pieces, plastics, rubber, glass, and ceramics.

### BRIEF DESCRIPTION OF THE DRAWINGS

FIG. 1 shows a cross sectional view of two beaded surfaces facing each other with interposing surface bonding geometry having regular equal spacing.

FIG. 2 shows a cross sectional view of two beaded surfaces interposed with a closed cell foam bonding agent.

FIG. 3 shows a cross sectional view of one surface having protrusions facing another surface having matching holes at regular repeated intervals.

FIG. 4 shows a cross sectional view of one beaded surface facing another surface having matching holes at regular repeated intervals bonded together with a bonding agent.

FIG. 5 shows a cross sectional view of two matched surfaces having protrusions and holes spaced at regular intervals.

FIG. 6 shows a cross sectional view of two matched surfaces having protrusions and holes spaced at regular intervals bonded together with a bonding agent.

FIG. 7 shows a cross sectional view of two beaded surfaces having a lock and key pattern of protrusions facing each other.

FIG. 8 shows a cross sectional view of two beaded surfaces having a lock and key pattern of protrusions bonded together with a bonding agent.

FIG. 9 shows a cross sectional view of one bonding surface having a lock and key pattern of protrusions facing a bonding surface having matched holes.

FIG. 10 shows a cross sectional view of one bonding surface having a lock and key pattern of protrusions bonded to a bonding surface having matched holes.

FIG. 11 shows a cross sectional view of two matched bonding surfaces facing each other having a lock and key pattern of matched protrusions and holes.

FIG. 12 shows a cross sectional view of two matched bonding surfaces having a lock and key pattern of matched protrusions and holes bonded together with a bonding agent.

FIG. 13 shows a cross sectional view of one bonding surface having a lock and key pattern of protrusions facing a bonding surface having matched holes having interlocking properties.

FIG. 14 shows a cross sectional view of one bonding surface having a lock and key pattern of protrusions bonded to a bonding surface having matched holes having interlocking properties.

FIG. 15 shows the top surface of a bonding construction having protrusions suitable for lock and key registration and/or verification with a matching surface.

### DESCRIPTION OF THE INVENTION

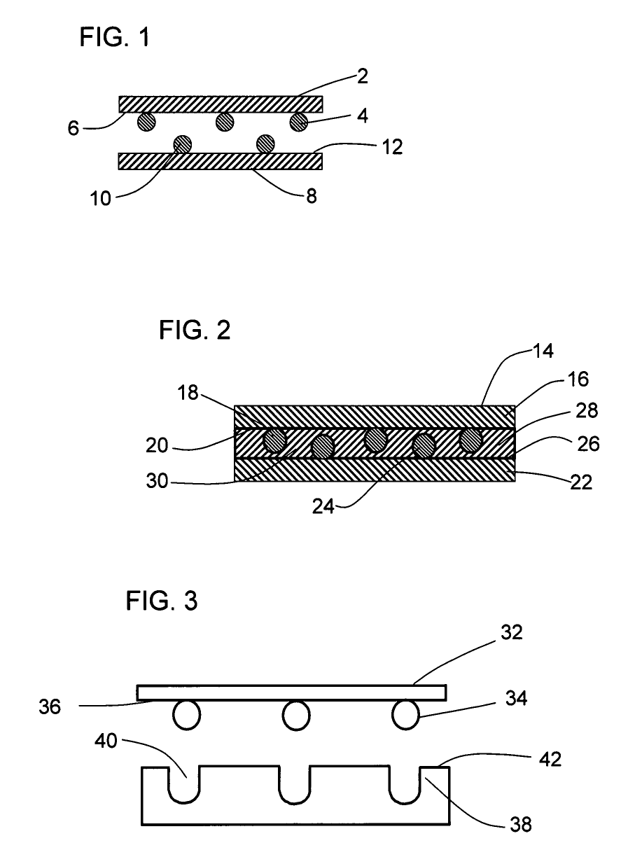

FIG. 1 shows two surfaces having protrusions facing each other with interposing surface bonding geometry. This particular geometry is suitable for numerous bonding applications. Top laminate portion 2 is shown having protrusions 4 extending in an outward direction from bottom surface portion 6 of top laminate portion 2. Also shown is bottom laminate portion 8. Bottom laminate 8 is shown having protrusions 10 extending in an outward direction from top portion 12 of bottom laminate 8.

FIG. 2 shows a sectional view of two surfaces having protrusions interposed with a bonding agent. Such bonding agents include polymers such as epoxy and polyester as well as other materials including closed cell foam. Bonded construction 14 is shown having top laminate portion 16 having protrusions 18 extending in an outward direction from bottom surface 20 of top beaded laminate portion 16. Also shown is bottom laminate portion 22 having protrusions 24 extending in an outward direction from top surface 26 of bottom laminate portion 22. Protrusions 18 of top laminate portion 16 are spaced equally with the same spacing as protrusions 24 of bottom laminate portion 22. Bonding agent 28 is also shown and fills in space 30 between top laminate portion 16 and bottom laminate portion 22.

FIG. 3 shows a cross sectional view of one surface having protrusions facing another surface having matching holes at regular intervals. This particular geometry is suitable for surface bonding and may be used for other bonding applications as well. Top laminate construction 32 is shown having protrusions 34 extending in an outward direction from bottom surface portion 36 of top laminate construction 32. Also shown is bottom laminate construction 38. Bottom laminate construction 38 is shown having holes 40 in top portion 42 of bottom laminate construction 38.

The regular spacing of protrusions on top laminate construction 32 and of holes in bottom laminate construction 38 may be used to produce good bonding but may not offer the benefit of one way fit. Additionally such a regular repeating pattern may not provide benefits associated with part verification and anti-counterfeit protection.

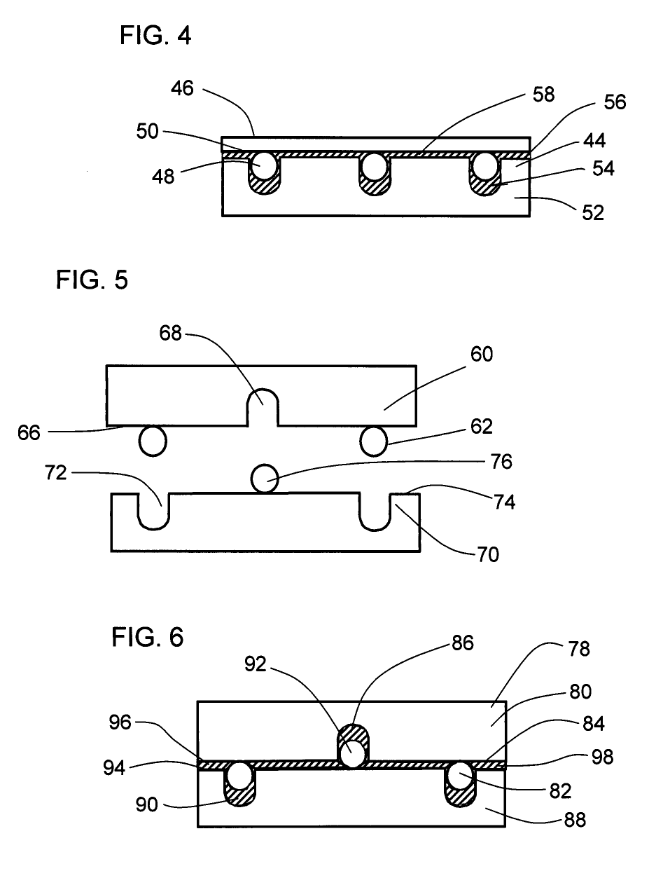

FIG. 4 shows a cross sectional view of one surface having protrusions facing another surface having matching holes at regular repeated intervals bonded together with a bonding agent. Bonded laminate construction 44 is shown having top laminate portion 46 having protrusions 48 extending in an outward direction from bottom surface 50 of top laminate portion 46 in a regular pattern. Also shown is bottom laminate portion 52 having holes 54 in matching configuration with protrusions 48 of top laminate portion 46. Also shown is bonding agent 56. Bonding agent 56 fills in space 58 between top laminate portion 46 and bottom laminate portion 52.

FIG. 5 shows a cross sectional view of two matched surfaces having protrusions and holes spaced at regular intervals. Top laminate construction 60 is shown having protrusions 62 extending in an outward direction from bottom surface 64 of top laminate construction 60. Also shown is hole 68. Hole 68 is a blind hole (does not go all of the way through) and originates on bottom surface 66 of top laminate construction 60. Also shown is bottom laminate construction 70 having holes 72 drilled into top portion 74 and protrusion 76.

FIG. 6 shows a cross sectional view of two matched surfaces having protrusions and holes spaced at regular intervals bonded together with a bonding agent. Bonded laminate construction 78 is shown having top laminate portion 80 having protrusions 82 extending in an outward direction from bottom surface 84 of top laminate portion 80 in a regular pattern. Also shown is hole 86 in top laminate portion 80. Bottom laminate portion 88 is shown having holes 90 in matching configuration with protrusions 82 of top laminate portion 80. Protrusion 92 is also shown extending in an outward direction from top surface portion 94 of bottom laminate portion 88. Also shown is bonding agent 96. Bonding agent 96 fills in space 98 between top laminate portion 80 and bottom laminate portion 88.

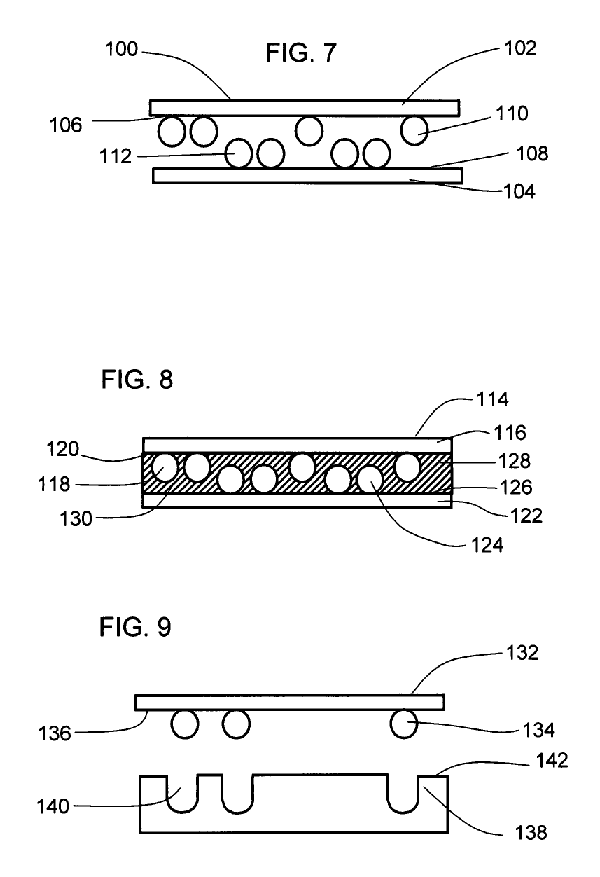

FIG. 7 shows a cross sectional view of two surfaces having a matched pattern of protrusions that fit together like a lock and key. Matched construction 100 is shown having top portion 102 and bottom portion 104. Also shown is the bottom surface 106 of top portion 102. Top surface portion 108 of bottom portion 104 is also shown. protrusions 110 are shown extending in an outward direction from surface 106 in matching opposing geometry to protrusions 112 extending in an outward direction from surface 108.

The matched pattern of beads fixedly attached and/or part of the surface provides a matched lock and key mechanism that may be configured to fit one way and one way only. In addition such a matched lock and key configuration may have numerous possible combinations. This system may therefore be used for individual part verification. Specific lock and key matched surface geometries may be particularly useful for the parts of vehicles such as automobiles.

FIG. 8 shows a sectional view of two bonded surfaces having a matched pattern that fit together like a lock and key. Bonded construction 114 is shown having top laminate portion 116 having protrusions 118 extending in an outward direction from bottom surface 120 of top laminate portion 116. Bottom surface 120 of top laminate portion 116 may be considered to be a first bonding surface. Also shown is bottom laminate portion 122 having protrusions 124 extending in an outward direction from top surface 126 of bottom laminate portion 122. Top surface 126 of bottom laminate portion 122 may be considered a second bonding surface. Protrusions 118 of top laminate portion 116 are spaced in a matching pattern to protrusions 124 of bottom laminate portion 122. This matching pattern is provided by the spaces between protrusions 124 of bottom laminate portion 122 matching the pattern of protrusions 118 extending in an outward direction from bottom surface 120 of top laminate portion 116. Bonding agent 128 is also shown and fills in space 130 between top laminate portion 116 and bottom laminate portion 122. It should be noted that bonding agent 128 is shown interlocking with protrusions 118 and 124.

FIG. 9 shows a cross sectional view of one surface having protrusions facing another surface having matching holes in a lock and key pattern. This particular geometry is suitable for surface bonding and may be used for other bonding applications as well. Top laminate construction 132 is shown having protrusions 134 extending in an outward direction from bottom surface portion 136 of top laminate construction 132. Also shown is bottom laminate construction 138. Bottom laminate construction 138 is shown having holes 140 in top portion 142 of bottom laminate construction 138.

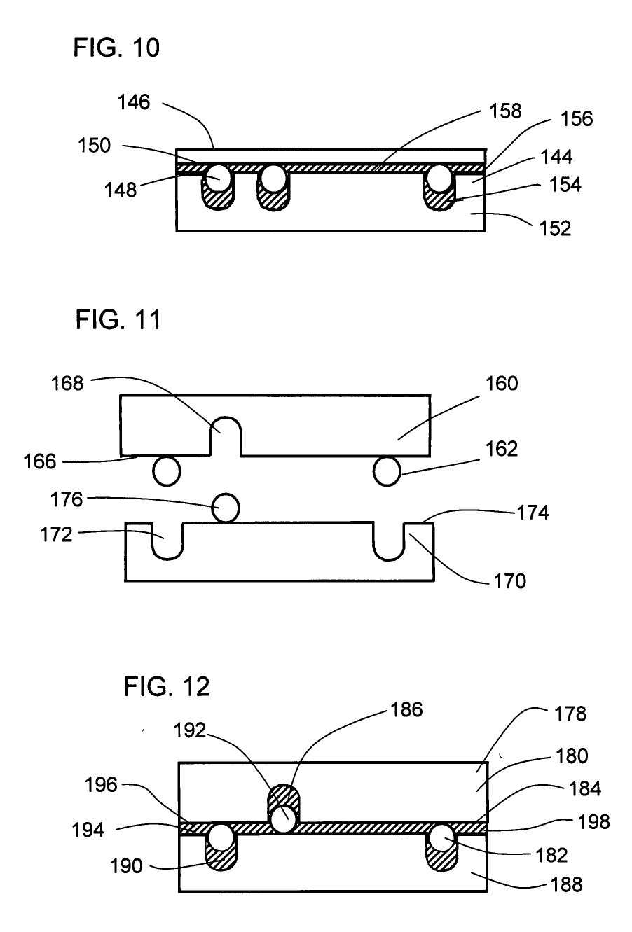

FIG. 10 shows a cross sectional view of one surface having protrusions facing another surface having matching holes in a lock and key pattern bonded together with a bonding agent. Bonded laminate construction 144 is shown having top laminate portion 146 having protrusions 148 extending in an outward direction from bottom surface 150 of top laminate portion 146 in a lock and key pattern. Also shown is bottom laminate portion 152 having holes 154 in matching configuration with protrusions 148 of top laminate portion 146. Also shown is bonding agent 156. Bonding agent 156 fills in space 158 between top laminate portion 146 and bottom laminate portion 152.

FIG. 11 shows a cross sectional view of two matched surfaces having protrusions and holes spaced in a lock and key pattern. Top laminate construction 160 is shown having protrusions 162 extending in an outward direction from bottom surface 164 of top laminate construction 160. Also shown is hole 168. Hole 168 is a blind hole (does not go all of the way through) and originates on bottom surface 166 of top laminate construction 160. Also shown is bottom laminate construction 170 having holes 72 drilled into top portion 174 and protrusion 176.

FIG. 12 shows a cross sectional view of two matched surfaces having protrusions and holes spaced in a lock and key pattern bonded together with a bonding agent. Bonded laminate construction 178 is shown having top laminate portion 180 having protrusions 182 extending in an outward direction from bottom surface 184 of top laminate portion 180 in a lock and key pattern. Also shown is hole 186 in top laminate portion 180. Bottom laminate portion 188 is shown having holes 190 in matching configuration protrusions 182 of top laminate portion 180. Protrusion 192 is also shown attached extending in an outward direction from surface portion 194 of bottom laminate portion 188. Also shown is bonding agent 196. Bonding agent 196 fills in space 198 between top laminate portion 180 and bottom laminate portion 188.

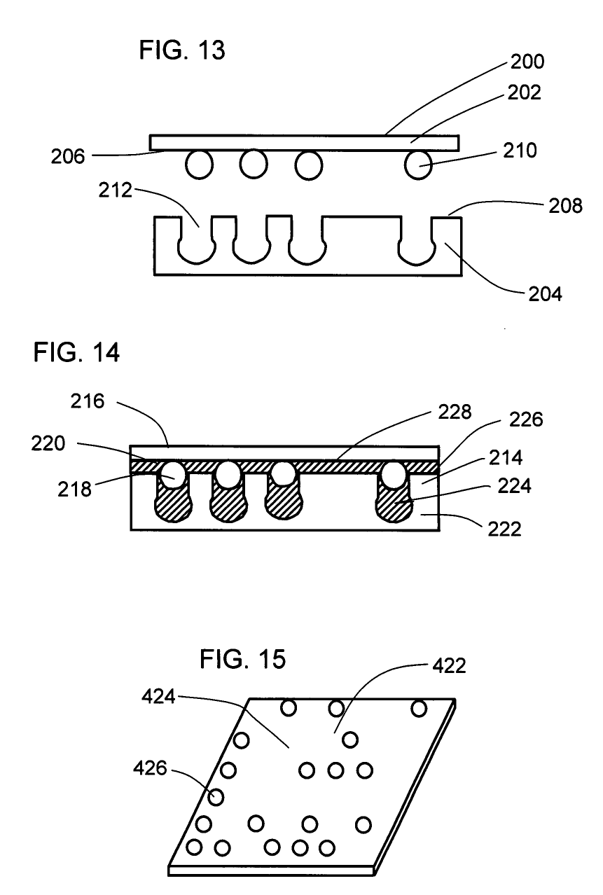

FIG. 13 shows a cross sectional view of a surface having protrusions and a surface having holes that fit together like a lock and key. Matched protrusion and hole construction 200 is shown having top portion 202 having protrusions 210 along with matched hole portion 204. Top portion 202 is shown having protrusions 210 extending in an outward direction from bottom surface portion 206 of top portion 202. Bottom matched hole portion 204 is shown having holes 212 located into top surface portion 208. It should be noted that holes 212 are shown as blind holes and therefore do not go all of the way through bottom portion 204.

FIG. 14 shows a cross sectional view of an interlocking bonding construction consisting of one surface having protrusions facing another surface having matching holes that fit together like a lock and key bonded together with a bonding agent. Bonded laminate construction 214 is shown having top laminate portion 216 having protrusions 218 extending in an outward direction from bottom surface 220 of top laminate portion 216 in a lock and key pattern. Bottom surface 220 of top laminate portion 216 may be considered to be a first bonding surface having a pattern of protrusions extending in an outward direction.

Also shown is bottom laminate portion 222 having holes 224 in matching configuration with protrusions 218 extending in an outward direction from laminate portion 216. Bottom laminate portion 222 having holes 224 may be considered to be a second bonding surface having holes arranged in a matching pattern to protrusions 218 to provide a one way fit between top laminate portion 216 and bottom laminate portion 222. Also shown is bonding agent 226. Bonding agent 226 fills in space 228 between top laminate portion 216 and bottom laminate portion 222. It should be noted that protrusions 218 extending from bottom surface 220 of top laminate portion 216 extend into holes 224 of bottom laminate portion 222.

FIGS. 13 and 14 are shown having blind holes that are wider at the bottom than at the top. This may result in improved interlocking properties compared with straight wall holes. Interlocking may be particularly important in forming strong bonds with incompatible materials.

FIG. 15 shows the top surface of a bonding construction having protrusions suitable for lock and key registration and/or verification with a matching surface. Construction 230 is shown with a pattern of protrusions 234 extending in an outward direction from top surface portion 232. Construction 230 is shown as a 6×7 matrix of protrusions. Even with a small matrix of this size, the number of possible combinations are numerous.

Those skilled in the art will understand that the preceding exemplary embodiments of the present invention provide foundation for numerous alternatives and modifications. These other modifications are also within the scope of the limiting technology of the present invention. Accordingly, the present invention is not limited to that precisely shown and described herein but only to that outlined in the appended claims.

What is claimed is:

1. An interlocking bonding construction for providing a one way fit between two bonding surfaces comprising:
a first bonding surface and a second bonding surface;
said first bonding surface having a pattern of protrusions extending in an outward direction from said surface toward said second bonding surface and;
said second bonding surface having holes;
said holes of said second bonding surface being arranged in a matching pattern to said protrusions extending in an outward direction from said first bonding surface thereby providing a one way fit between said holes of said second bonding surface and said protrusions extending in an outward direction from said first bonding surface;
a bonding agent such as epoxy;
said protrusions extending in an outward direction from said first bonding surface having contact with said bonding agent and;
said bonding agent having contact with said holes of said second bonding surface;
wherein said protrusions extending outward from said first bonding surface extend into said holes of said second bonding surface.

2. An interlocking bonding construction for providing a one way fit between two bonding surfaces comprising:
a first bonding surface and a second bonding surface;
said first bonding surface having a pattern of protrusions extending in an outward direction from said surface toward said second bonding surface and;
said second bonding surface having protrusions extending in an outward direction toward said first bonding surface;
said protrusions extending in an outward direction from said second bonding surface being arranged and spaced in such a manner as to provide spaces between said protrusions extending in an outward direction from said second bonding surface in a matching pattern to said protrusions extending in an outward direction from said first bonding surface thereby providing a one way fit between said spaces between said protrusions of said second bonding surface and said protrusions extending in an outward direction from said first bonding surface;
a bonding agent such as epoxy;
said protrusions extending in an outward direction from said first bonding surface having contact with said bonding agent and;
said bonding agent having contact with said spaces between said protrusions extending in an outward direction from said second bonding surface;
wherein said protrusions extending outward from said first bonding surface extend into said spaces between said protrusions of said second bonding surface.
